(19) United States
(12) Patent Application Publication
(10) Pub. No.: US 2007/0257160 A1
(43) Pub. Date: Nov. 8, 2007

(54) Cable attaching clamp

(75) Inventor: Paul Arthur Cushion, Dunstable, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-COM, Inc., Lowell, MA (US)

(21) Appl. No.: 11/429,810

(22) Filed: May 8, 2006

(51) Int. Cl. F16L 3/08

(52) U.S. Cl. 248/74.1; 248/300

(57) ABSTRACT

A clamp for securing a cable to a base plate includes a base with at least one upwardly extending arm, and a cable securing portion at the end of the arm. The arm of the clamp may be secured within a slot defined within the base plate. The cable securing portions may be crimped around a cable. The entire assembly may be soldered with a single soldering step.

### FIELD OF THE INVENTION

The present invention relates to the attachment of electrical cables to appliances. More specifically, the invention provides a clamp that simplifies the attachment of an electrical cable such as a coaxial cable to a base plate forming a portion of an appliance.

### BACKGROUND

Various electrical cables, for example, radio frequency coaxial cables, are commonly used to carry various electrical signals to various appliances. One present method for attaching such a cable includes a machined cable block soldered to the base plate to which the cable will be attached. The cable is attached to the machined cable block, and then soldered in place. The result is a two-step soldering process: soldering the cable block to the base plate, and then soldering the cable to the cable block.

Other presently available attachment means include bushings that are attached to a cable prior to securing the cable to the base plate. The base plate is provided with a receiving boss that is either threaded to receive a threaded cable bushing, or is structured to receive a press fit cable bushing. The need to provide a boss to receive the cable bushing increases the cost of the connection.

Accordingly, a more cost effective method of joining a cable to a base plate of an appliance is desired.

### SUMMARY OF THE INVENTION

The above described needs are met by the present invention, which provides a clamp for securing a cable to a base plate. The clamp is structured so that it may be crimped around a cable, and may fit within a slot defined within the base plate. A single soldering operation may be used to solder the cable to the clamp, and the clamp to the base plate.

According to one aspect of the invention, a clamp may include a base having at least one arm extending upward from the end of the base. The arm is structured to be secured within a slot defined within the base plate. The arm includes a cable securing portion at its free end.

According to another aspect of the invention, a method of making a clamp is provided. The clamp may be made by cutting a one piece structure including the base, arms, and cable securing portions from a single piece of an appropriate material.

These and other features of the invention will become more apparent through the following description and drawings.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a front elevational view of a clamp according to the present invention.

FIG. 2 is a top plan view of a clamp according to the present invention.

FIG. 3 is a side elevational view of a clamp according to the present invention.

FIG. 4 is a top plan view of a clamp according to the present invention, prior to bending of the arms upward to the configuration shown in FIGS. 1-3.

FIG. 5 is a top isometric view of an assembly of a clamp, base plate, and cable according to the present invention.

FIG. 6 is an exploded top isometric view of a clamp, base plate, and cable of FIG. 5.

Like reference characters denote like elements throughout the drawings.

### DETAILED DESCRIPTION

The present invention provides a clamp for securing a cable, for example a radio frequency coaxial cable, to a base plate that may be a portion of an appliance. The appliance may be, for example, a wireless cellular telephone base station, a dual junction ferrite isolator/circulator, or any other appliance or application where a coaxial cable needs to be attached to a base plate at a point where the cable terminates.

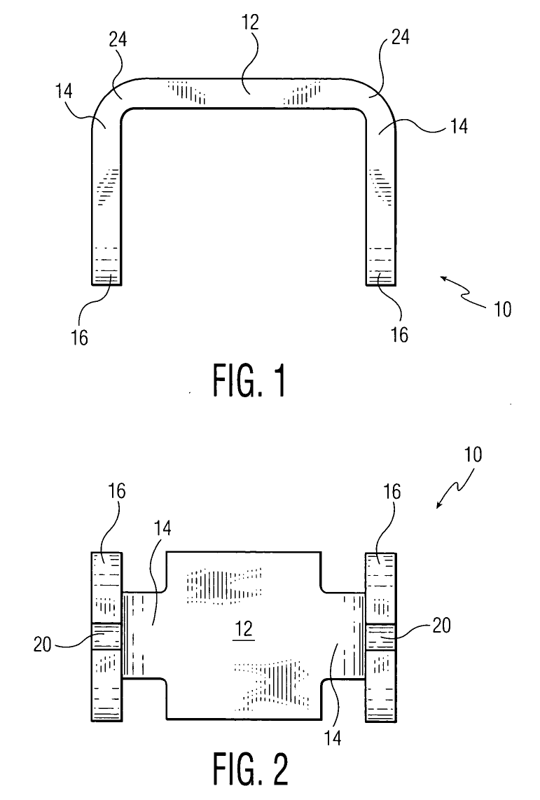

Referring to FIGS. 1-3, the clamp 10 includes a base 12 having at least one arm 14 extending upward from the base 12. The illustrated example of the clamp 10 includes a pair of arms 14 extending upward from opposing sides of the base 12. The arms 14 preferably have a width that is narrower than the width of the base 12.

A cable securing portion 16 is disposed at the free end of each of the arms 14. The illustrated example of the cable securing portion 16 has a C-shaped configuration defining a cable receiving recess 18 therein. In the illustrated example, the opening 20 defined within the C-shaped structure of the cable securing portion 16 is opposite the arm 14, and faces upward. However, other locations for the opening 20 may be used without departing from the invention.

The clamp 10 may be made from any material that lends itself to crimping, and which is suitable for soldering. Examples include aluminum, copper, brass and steel. Alternatively, the cable securing portions 16 may be dimensioned and configured so that they secure a cable therein without crimping.

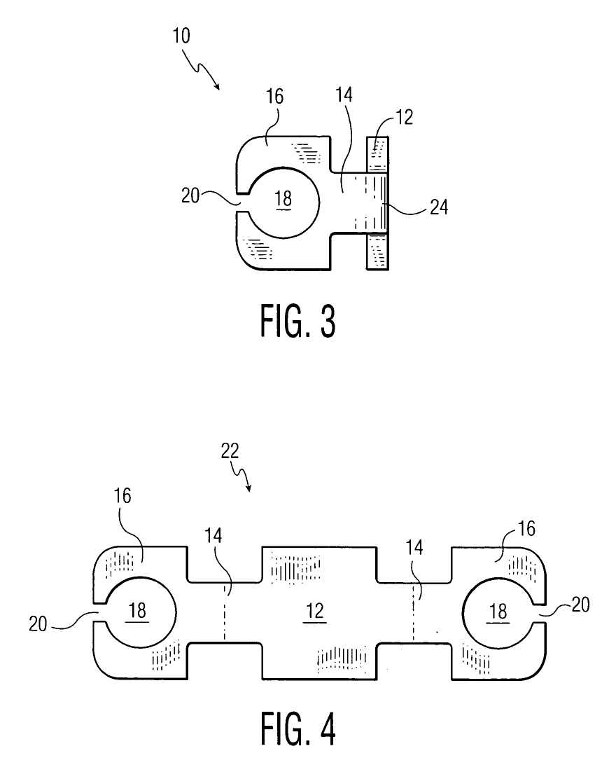

The clamp 10 may be made by cutting an intermediate structure 22 (FIG. 4) having the base 12, arms 14, and cable securing portion 16 as a substantially flat, one piece assembly. The cutting may be performed by cutting procedures such as stamping or electrodischarge machining. The resulting intermediate structure 22 includes relatively narrow arms 14 as compared to the base 12 and cable securing portions 16, thereby defining a notch between the base 12 and each cable securing portion 16. A bend 24 may be formed in each arm 14 to form the U-shaped profile of the final clamp 10.

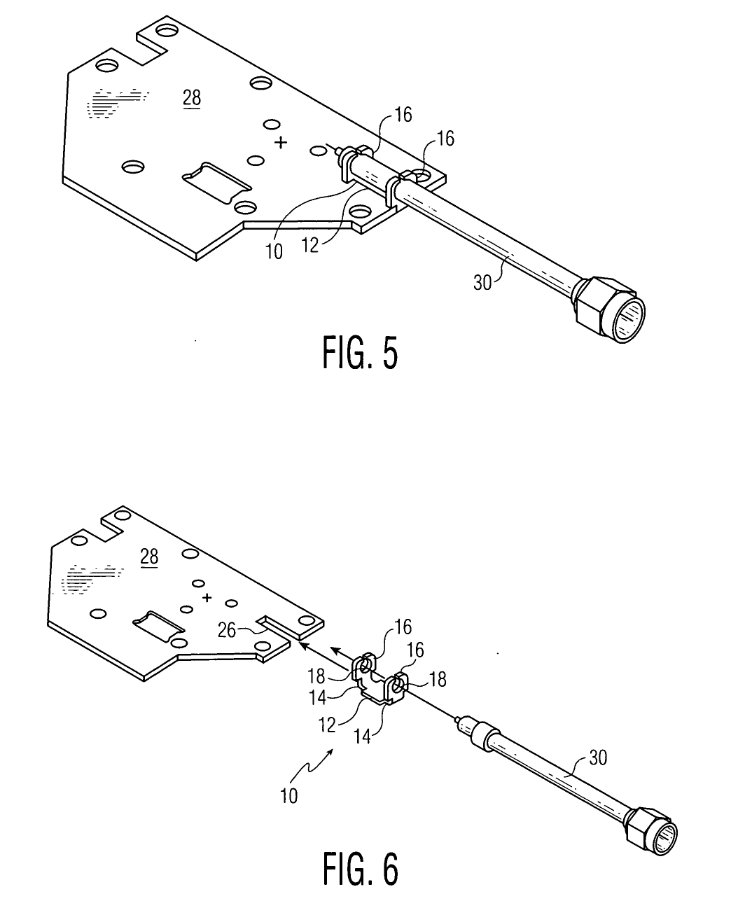

Referring to FIGS. 5-6, in use, the arms 14 of the clamp 10 may be slid into a slot 26 defined within a base plate 28. With the arms 14 in the slot 26, the base plate fits within the notch defined between the base 12 and cable securing portions 16, so that substantial movement of the clamp 10 in any direction except through the open end of the slot 26 is resisted. A cable 30, for example, the illustrated radio frequency coaxial cable, is then inserted into the cable receiving recesses 18 of the cable securing portions 16. The cable receiving portions 16 are crimped over the cable 30. A single soldering operation is used to secure the cable 30 within the cable securing portions 16, and to further secure the clamp 10 to the base plate 28.

The present invention therefore provides a clamp that may be used to secure a cable to a base plate in a manner that reduces the cost of the cable securing operation as compared to prior cable securing methods. The invention further provides a clamp that may be secured to a base plate without the use of any bosses provided on the base plate. Additionally, the invention provides a clamp that may be used to secure a cable to a base plate, requiring only a single soldering operation.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A clamp for securing a cable to a base plate, the base plate having a slot defined therein, the clamp comprising:
a base;
at least one arm extending upward from the base, the arm being structured to fit within the slot defined within the base plate; and
a cable securing portion disposed at an end of the at least one arm.

2. The clamp according to claim 1, wherein the at least one arm comprises a pair of arms extending upward from opposing ends of the base, the arms being structured to fit within the slot defined within the base plate.

3. The clamp according to claim 1, wherein the cable securing portion has a C-shaped configuration.

4. The clamp according to claim 3, wherein the cable securing portion is open at its upper end, and secured to the arm at its lower end.

5. The clamp according to claim 1, wherein the cable securing portion is open at its upper end, and secured to the arm at its lower end.

6. The clamp according to claim 1, wherein the cable securing portion is pre-shaped to fit around a cable.

7. The clamp according to claim 1, wherein the clamp is made from one-piece construction.

8. A clamp and base plate assembly for securing a cable to the base plate, the assembly comprising:
a base plate defining a slot therein; and
a clamp, comprising:
a base;
at least one arm extending upward from the base, the arm being structured to fit within the slot defined within the base plate; and
a cable securing portion disposed at an end of each of the arms.

9. The assembly according to claim 8, wherein the at least one arm comprises a pair of arms extending upward from opposing ends of the base, the arms being structured to fit within the slot defined within the base plate.

10. The assembly according to claim 8, wherein the cable securing portion has a C-shaped configuration.

11. The assembly according to claim 10, wherein the cable securing portion is open at its upper end, and secured to the arm at its lower end.

12. The assembly according to claim 8, wherein the cable securing portion is pre-shaped to fit around a cable.

13. The assembly according to claim 8, wherein the cable securing portion is structured to be bent around a cable.

14. The assembly according to claim 8, wherein the clamp is made from one-piece construction.

15. A method of making a clamp for securing a cable to a base plate, the method comprising:
providing a base, at least one arm extending outward from the base, and a cable securing portion extending outward from the at least one arm; and
bending the at least one arm upward.

16. The method according to claim 15, further comprising cutting the base, at least one arm, and cable securing portions from a single piece of raw material.

17. A method of securing a cable to a base plate, the method comprising:
providing a clamp structured to fit within a slot defined within the base plate; and
securing the cable within the clamp.

18. The method according to claim 17, further comprising soldering the clamp to the base plate.

19. The method according to claim 18, wherein the cable is soldered within the clamp at the same time as the clamp is soldered to the base plate.

20. The method according to claim 17, further comprising soldering the cable within the clamp.
